(19) United States
(12) Patent Application Publication
(10) Pub. No.: US 2023/0033624 A1
(43) Pub. Date: Feb. 2, 2023

(54) GENERATING SYSTEM USING FUEL CELL AND METHOD FOR CONTROLLING THE SAME

(71) Applicants: Hyundai Motor Company, Seoul (KR); Kia Corporation, Seoul (KR)

(72) Inventors: Yong Doo SON, Incheon (KR); Jung Tak KANG, Incheon (KR)

(73) Assignees: Hyundai Motor Company, Seoul (KR); Kia Corporation, Seoul (KR)

(21) Appl. No.: 17/738,111

(22) Filed: May 6, 2022

(30) Foreign Application Priority Data
Aug. 2, 2021 (KR) 10-2021-0101394

(51) Int. Cl. H02M 7/537; H01M 8/249

(52) U.S. Cl. CPC H02M 7/537; H01M 8/249

(57) ABSTRACT

A generating system using fuel cells, includes a plurality of fuel cell stacks; a plurality of power converters, wherein each of the power converters is connected to a corresponding fuel cell stack of the fuel cell stacks and configured for adjusting an output of the connected fuel cell stack and performing direct current—alternating current conversion; and a controller which is configured to individually control the respective power converters so that a total output of the plurality of power converters converges on a required system output while varying the output of the respective power converters, and a method for controlling the same.

### CROSS-REFERENCE TO RELATED APPLICATION

The present application claims priority to Korean Patent Application No. 10-2021-0101394, filed Aug. 2, 2021, the entire contents of which is incorporated herein for all purposes by this reference.

### BACKGROUND OF THE PRESENT DISCLOSURE

### Field of the Present Disclosure

The present disclosure relates to a generating system using fuel cells, which, by variably controlling the output of individual fuel cells, improves fuel cell durability relative to constant voltage control and provides stable output, and by performing variable output control while also ensuring overall output requirement, allows for stable performance and uninterrupted supply of power without overall system shutdown even in the event of failure of some of the fuel cells, and a method for controlling the same.

### Description of Related Art

Conventional fuel cell systems for power generation have a Single Input Single Output (SISO) structure, making individual fuel cell control impossible. As a result, the entire system has to be shut down even in the case of a single malfunctioning stack, causing the stability of electric power supply to be very low.

Furthermore, whereas conventional fuel cell systems for power generation are based on constant and continuous output of a prescribed output, continuous output of constant output is disadvantageous to the stack (generator) of a fuel cell system in terms of performance and durability

That is, in the case of a conventional fuel cell for power generation, variable output control (adjusting stack output (DC)) would cause fluctuations in overall system output (AC), leading to system instability. Accordingly, the inability to use variable control caused problems of reduced fuel cell durability was caused, and as a result the entire system would may be shut down in the event of a fuel cell failure.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a generating system using fuel cells, which, by variably controlling the output of individual fuel cells, improves fuel cell durability relative to constant voltage control and provides stable output, and by performing variable output control while also ensuring overall output requirement, allows for stable performance and uninterrupted supply of power without overall system shutdown even in the event of failure of some of the fuel cells, and a method for controlling the same.

The generating system using fuel cells according to an exemplary embodiment of the present disclosure, to achieve the above-stated purposes, includes: a plurality of fuel cell stacks; a plurality of power converters which adjust the output of fuel cell stacks connected thereto and which perform direct current—alternating current conversion; and a controller which is configured to individually control the respective power converters so that a total output of the plurality of power converters converges on a required system output while varying an output of the respective power converters.

The respective output terminals of the plurality of power converters may be connected through a grid linker, and the total output may be provided at the grid linker.

A synchronizer for synchronizing the outputs of the plurality of power converters may be further included.

The plurality of fuel cell stacks may be organized into a plurality of groups, and the power converters connected to the fuel cell stacks of the respective groups may be synchronized through the synchronizer to provide uniform output.

The plurality of fuel cell stacks may be organized into two groups, and the controller may be configured to control the power converters so that the groups have opposite phases.

The plurality of fuel cell stacks may be organized into a plurality of groups, with the power converters connected to the fuel cell stacks within each group synchronized through the synchronizer to provide uniformly variable output, and the controller configured for controlling the output of the power converters of each group so that the total output of the plurality of groups converges upon the required system output.

The plurality of fuel cell stacks may be organized into a plurality of groups, and when some of the groups are stopped, the controller may be configured to control remaining groups among the groups to constant voltage output.

When the stopped groups are restarted, the controller may be configured to control the restarted group to constant voltage output, and when the restarted groups have reached constant voltage output, the system may control each group so that the output of the power converters is varied for the required system output to be converged upon.

The fuel cell stack may be a fuel cell stack for a vehicle.

The method for controlling a generating system using fuel cells according to an exemplary embodiment of the present disclosure includes: checking, at a controller, normal operation of the respective fuel cell stacks; and controlling, at the controller, the outputs of the respective power converters to be variable, so that the total output of the plurality of power converters converges upon the required system output.

According to the generating system using fuel cells and method for controlling the same of the present disclosure, by variably controlling the output of individual fuel cells, it is possible to improve fuel cell durability relative to constant voltage control and provide stable output, and by performing variable output control while also ensuring overall output requirement, stable performance and uninterrupted supply of power without overall system shutdown even in the event of failure of some of the fuel cells is possible.

The methods and apparatuses of the present disclosure have other features and advantages which will be apparent from or are set forth in more detail in the accompanying drawings, which are incorporated herein, and the following Detailed Description, which together are configured to explain predetermined principles of the present disclosure.

### BRIEF DESCRIPTION OF THE DRAWINGS

FIG. 1 and FIG. 2 are structure charts of the generating system using fuel cells according to various exemplary embodiments of the present disclosure.

FIG. 3 is a flow chart of the method for controlling the generating system using fuel cells according to various exemplary embodiments of the present disclosure.

FIG. 4 is a graph showing the output of the generating system using fuel cells according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

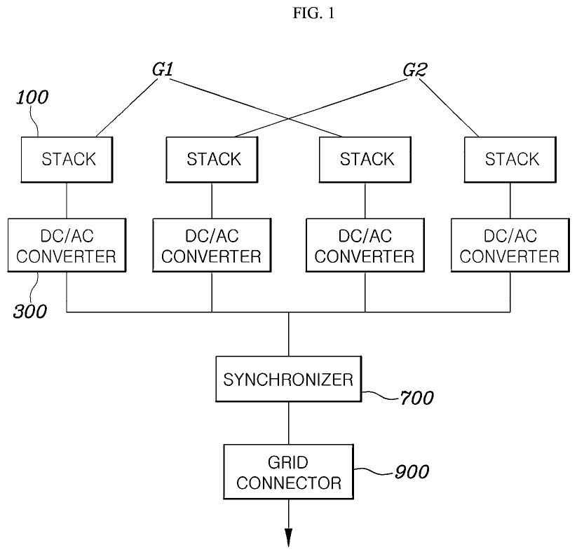

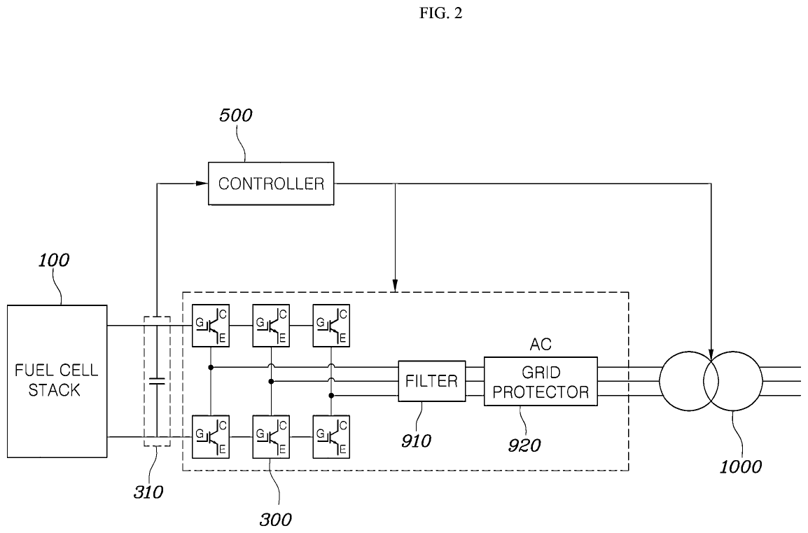

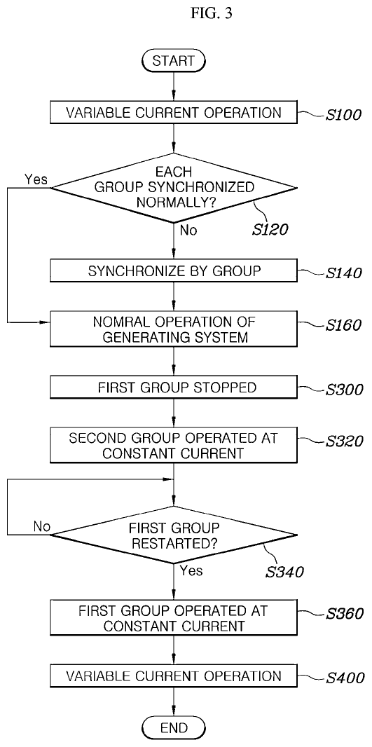

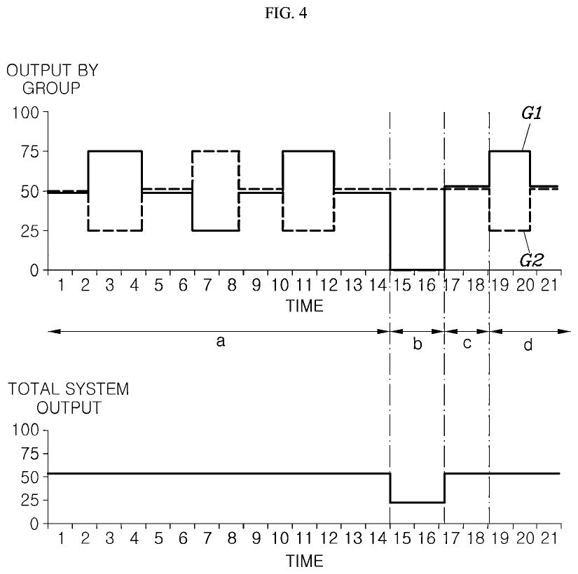

FIG. 1 and FIG. 2 are structure charts of the generating system using fuel cells according to various exemplary embodiments of the present disclosure, FIG. 3 is a flow chart of the method for controlling the generating system using fuel cells according to various exemplary embodiments of the present disclosure, and FIG. 4 is a graph showing the output of the generating system using fuel cells according to various exemplary embodiments of the present disclosure.

FIG. 1 and FIG. 2 are structure charts of the generating system using fuel cells according to various exemplary embodiments of the present disclosure. The generating system using fuel cells according to an exemplary embodiment of the present disclosure includes a plurality of fuel cell stacks 100; a plurality of power converters 300 which are connected to respective fuel cell stacks 100 and adjust the output of fuel cell stacks 100 connected thereto and which perform direct current—alternating current conversion; and a controller 500 which individually controls the respective power converters 300 so that the total output of the plurality of power converters 300 converges on the required system output while varying the output of the respective power converters 300.

The generating system using fuel cells of the present disclosure is for using and operating the powertrain of a vehicle fuel cell system as a generating system. To the present end, fuel cells can be recycled, and it becomes possible to effectively use idle resources. Of course, the fuel cells used in an exemplary embodiment of the present disclosure may also be part of a fuel cell stack fabricated separately for the system of the present disclosure.

The key element of the present disclosure is a fuel cell system that utilizes hydrogen as fuel. Fuel cell systems including modular stacks or stack assemblies may also be used. Alternatively, systems, wherein stack modules are connected in parallel may also be used, and the system may be provided with a power transmission system able to transmit power generated by fuel cells independently or through a grid. Furthermore, the fuel cell system may be provided with power converters 300 which are configured for individual control of modules and able to vary grid output depending on fuel cell performance. Such power converters can exhibit efficiency/price/performance improvements over conventional converters.

The power converter of a conventional fuel cell system for power generation is of the SISO type, wherein the entire system must be shut down when a single stack module fails and individual stack power generation is difficult to control. However, the present disclosure is of the MISO (Multi Input Single Output (MISO) type, wherein each fuel cell module may be controlled individually, maintenance is facilitated, and power generation may be controlled according to stack performance.

The respective output terminals of the plurality of power converters matched with each of the fuel cell stacks of the present disclosure may be connected through a grid linker 900, and total system output may be provided at the grid linker 900.

The power converter 300 in an exemplary embodiment of the present disclosure is an inverter for power generation, converting the DC power generated by a fuel cell into AC power required for power generation. The power converter also adjusts generation module (stack) output, and fuel cell stack output follows load.

Furthermore, for linkage with other large electric power providers, a voltage/frequency synchronization function with the power grid is necessary, and it is necessary to minimize grid disturbance elements. Accordingly, the power converter 300 is the final output element for the power generated in a fuel cell system for power generation, and corresponds to a core technology and element.

Constant and continuous output of a prescribed output is fundamental for a fuel cell system for power generation. However, continuous output of a constant output is disadvantageous in terms of performance and durability for the stack (generator) of a fuel cell system. Therefore, operating the stack at variable output, not constant output, is advantageous in terms of improving stack durability and performance.

Meanwhile, in the case of conventional fuel cells for power generation, variable output (adjusting stack output (DC)) causes fluctuations in grid output (AC) and in turn grid instability. Accordingly, the concept provided as an exemplary embodiment of the present disclosure applies variable current operation to improve fuel cell stack performance and extend life, while also minimizing change in grid output.

To implement such variable current operation, each stack 100 is assigned a power converter 300. Accordingly, each fuel cell stack 100 is configured independently, facilitating maintenance and hot swapping of the respective stacks 100.

Furthermore, whereas configuring the respective power converter 300 independently has the possibility of circulating current due to a closed loop, the problem of circulating current may be mitigated through the function of the synchronizer 700 of each power converter.

Meanwhile, the present disclosure, by having a structure providing a plurality of power converters 300 for input of multi-channel power from the fuel cells, can expect cost savings through use of a common grid linker module. By adjusting power generation according to the performance of each stack, operation at optimized efficiency is possible. Furthermore, when a certain stack fails during operation, the stack in question may be removed and repaired instead of having to shut down the entire system, ensuring stable power supply.

Meanwhile, to improve the endurance of the fuel cells, variable operating modes (sine wave, square wave, complex waveform) for optimized stack operation are possible. That is, it is possible to operate at variable current to improve durability of the stack, which is the core component of the fuel cell system for power generation, while minimizing fluctuations in the amount of power generated supplied to the grid.

By operating the respective fuel cell stacks 100 at variable current, with, for example, the odd-numbered stacks and the even-numbered stacks organized into respective groups G1 and G2, and synchronously controlling the output current of the groups with a 180° phase difference, it becomes possible to send the same output the grid at all times. Through such variable current control, flooding of the fuel cell stacks may be prevented, achieving performance improvement. Furthermore, formation of an oxide coating on the stack catalyst is prevented, suppressing catalyst deterioration and improving durability.

To the present end, a voltage sensing module 310 which measures the voltage of the fuel cell DC output is provided. Furthermore, a controller 500 is provided to detect fuel cell voltage and monitor output voltage for synchronization of the currents of each module. The controller 500 controls power generation and voltage output. The power converter 300 performs DC→AC power conversion, and is provided with a grid monitor/protector 920 and a transformer 1000 (for example, a 3-phase, 3-line dual input transformer). Furthermore, filters 910 (noise filter, cap, etc.) are provided to protect the generator module. Also, the synchronizer 700 synchronizes the output of a plurality of power converters.

In the generating system of the present disclosure, the plurality of fuel cell stacks 100 may be organized into a plurality of groups G1 and G2, and the power converters 300 connected to the fuel cell stacks 100 in the respective groups G1 and G2 may be synchronized through a synchronizer 700 to provide uniform output. Accordingly, the grouped fuel cells can provide uniform and variable output. Provided, that the respective groups provide different output while the total overall output is maintained uniformly. That is, the plurality of fuel cell stacks 100 may be organized into a plurality of groups G1 and G2, the power converters 300 connected to the fuel cell stacks 100 in the respective groups G1 and G2 may be synchronized through a synchronizer 700 to provide uniformly variable output, and the controller 500 may control the output of the power converters 300 of each group G1 and G2 so that the total output of the plurality of groups G1 and G2 converges upon the required system output.

For example, the plurality of fuel cell stacks may be organized into two groups G1 and G2, and the controller 500 may control the power converters 300 so that the groups G1 and G2 have opposite phases.

FIG. 4 is a graph showing the output of the generating system using fuel cells according to various exemplary embodiments of the present disclosure. In the graph, section a illustrates a case where output is provided so that a first group G1 and a second group G2 have opposite phases to each other. It may be seen that, as shown in the graph below, a constant total system output of 50 is provided.

Meanwhile, the plurality of fuel cell stacks may be organized into a plurality of groups G1 and G2, and when one group G1 is stopped, the controller may be configured to control the remaining group G2 to constant current output. When the stopped group G1 is restarted, the controller may be configured to control the restarted group G1 to constant current output, and when the restarted group G1 has reached constant current output, the controller 500 may control the outputs of the power converters 300 of the respective groups G1 and G2 so that the outputs converge upon the required system output.

For example, in the case of section b in FIG. 4, when the fuel cells of the first group G1 stop generating power, the second group G2 performs constant current output normally. Accordingly, total system output decreases slightly as shown in the graph below, and only around 25 output is provided, but the supply of power is more stable compared to a shutdown. Accordingly, when as shown in section c, the first group G1 is normalized, the first group G1 and the second group G2 may be controlled to have opposite phases as shown in section d, and thereby constant output may be provided in all sections except for section b.

FIG. 3 is a flow chart of the method for controlling the generating system using fuel cells according to various exemplary embodiments of the present disclosure. The method for controlling the generating system using fuel cells of the present disclosure includes: checking, at a controller, normal operation of the respective fuel cell stacks; receiving, at the controller, input of a required system output;, and controlling, at the controller, the outputs of the respective power converters to be variable, so that the total output of the plurality of power converters converges upon the required system output.

First, the respective groups are operated at variable current (S100). Accordingly, whether each group have been synchronized normally is checked (S120, S140). When it is judged that synchronization is normal, the generation system is variably controlled to maintain total output (S160).

In the present state, when an issue arises with some of the fuel cells or some of the fuel cells require repair, that is, when the first group is stopped, then the second group is made to maintain constant current (S300, S320). When the first group is normalized and restarted, the first group is operated at constant voltage, then made to operate normally at variable current together with the second group, ensuring overall power supply is not stopped or interrupted (S340, S360, S400).

According to the generating system using fuel cells and method for controlling the same of the present disclosure, by variably controlling the output of individual fuel cells, it is possible to improve fuel cell durability relative to constant voltage control and provide stable output, and by performing variable output control while also ensuring overall output requirement, stable performance and uninterrupted supply of power without overall system shutdown even in the event of failure of some of the fuel cells is possible.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A generating system using fuel cells, the system comprising:
a plurality of fuel cell stacks;
a plurality of power converters, wherein each of the power converters is connected to a corresponding fuel cell stack of the fuel cell stacks and configured for adjusting an output of the connected fuel cell stack and performing direct current — alternating current conversion; and
a controller which is configured to individually control the respective power converters so that a total output of the plurality of power converters converges on a required system output while varying an output of the respective power converters.

2. The generating system of claim 1, wherein respective output terminals of the plurality of power converters are connected through a grid linker, and wherein the total output is provided at the grid linker.

3. The generating system of claim 1, further including a synchronizer for synchronizing the outputs of the plurality of power converters.

4. The generating system of claim 1,
wherein the plurality of fuel cell stacks is organized into a plurality of groups, and
wherein the power converters connected to the fuel cell stacks of the respective groups are synchronized through the synchronizer to provide uniform output.

5. The generating system of claim 1,
wherein the plurality of fuel cell stacks is organized into two groups, and
wherein the controller is configured to control the power converters so that the two groups have opposite phases.

6. The generating system of claim 1,
wherein the plurality of fuel cell stacks is organized into a plurality of groups, with the power converters connected to the fuel cell stacks within each group synchronized through a synchronizer to provide uniformly variable output, and
wherein the controller is configured to control the output of the power converters of each group so that the total output of the plurality of groups converges upon the required system output.

7. The generating system of claim 1,
wherein the plurality of fuel cell stacks is organized into a plurality of groups, and
wherein when some of the groups are stopped, the controller is configured to control remaining groups among the groups to constant voltage output.

8. The generating system of claim 7,
wherein when the stopped group is restarted, the controller is configured to control the restarted group to constant voltage output, and
wherein when the restarted group has reached the constant voltage output, the system controls each group so that the output of the power converters is varied for the required system output to be converged upon.

9. The generating system of claim 1, wherein the fuel cell stack is a fuel cell stack for a vehicle.

10. A method for controlling the generating system of claim 1, the method comprising:
checking, by the controller, normal operation of the respective fuel cell stacks; and
controlling, by the controller, the output of the respective power converters to be variable, so that the total output of the plurality of power converters converges upon the required system output.

11. The method claim 10,
wherein the plurality of fuel cell stacks is organized into a plurality of groups, and
wherein when some of the groups are stopped, the controller is configured to control remaining groups among the groups to constant voltage output.

12. The method of claim 11,
wherein when the stopped group is restarted, the controller is configured to control the restarted group to constant voltage output, and
wherein when the restarted group has reached the constant voltage output, the controller is configured to control each group so that the output of the power converters is varied for the required system output to be converged upon.

13. The method of claim 11,
wherein the plurality of fuel cell stacks is organized into two groups, and
wherein the controller is configured to control the power converters so that the two groups have opposite phases.

14. The method of claim 13,
wherein when a first group of the two groups is stopped, the controller is configured to control a second group of the two groups to maintain constant current, and
wherein when the first group is normalized and restarted, the controller is configured to control the first group to be operate at constant voltage and then to operate normally at variable current together with the second group.
